(19) United States
(12) Patent Application Publication
(10) Pub. No.: US 2019/0279058 A1
(43) Pub. Date: Sep. 12, 2019

(54) FACILITATING EFFICIENT READING OF RADIO FREQUENCY IDENTIFICATION TAGS

(71) Applicant: Microsoft Technology Licensing, LLC, Redmond, WA (US)

(72) Inventors: Amer Aref HASSAN, Kirkland, WA (US); Abhi ABHISHEK, Redmond, WA (US)

(21) Appl. No.: 15/919,058

(22) Filed: Mar. 12, 2018

(51) Int. Cl. G06K 17/00; G06K 7/10; G06K 7/00

(52) U.S. Cl. CPC G06K 17/0029; G06K 19/07796; G06K 7/0008; G06K 7/10475

(57) ABSTRACT

A method for facilitating efficient reading of radio frequency identification (RFID) tags may include encoding a sequence of information bits using an error-correcting code to generate encoded information. The sequence of information bits may be associated with an object. The encoded information may be distributed among a plurality of RFID tags such that recovering the sequence of information bits does not require all of the plurality of RFID tags to be read correctly. The plurality of RFID tags may be attached to the object.

### CROSS-REFERENCE TO RELATED APPLICATIONS

N/A

### BACKGROUND

Radio-frequency identification (RFID) is a technology that uses radio-frequency (RF) electromagnetic fields to transfer data for the purpose of automatically identifying objects. RFID technology is used in many different industries for a wide variety of applications, including asset tracking, item-level tagging in retail stores, toll collection, access control, contactless payment, timing sporting events, and so forth.

An RFID system utilizes RFID tags and an RFID tag reader. The RFID tags may be attached to various objects to be identified. RFID tags can be passive, active, or battery-assisted passive. An active RFID tag has an on-board battery and periodically transmits an ID signal. A battery-assisted passive RFID tag includes a battery and may be activated when in the presence of an RFID tag reader. A passive RFID tag does not include a battery but instead uses the radio energy transmitted by the RFID tag reader.

RFID tags may include non-volatile memory for storing a unique identifier and other information. Data that is related to a particular object may be written to the non-volatile memory within an RFID tag. The RFID tag may be attached to the object to facilitate object tracking.

RFID systems may be classified by the type of RFID tags and the type of RFID tag readers being used. For example, in some RFID systems, an active RFID tag reader may transmit a signal to interrogate passive RFID tags. Upon receiving a signal from the RFID tag reader, an RFID tag may respond with its identifier and other stored information. Alternatively, in some other RFID systems, a passive RFID tag reader may receive signals from active RFID tags. Because RFID tags have unique identifiers, an RFID system may be able to discriminate among several RFID tags that might be within the range of an RFID tag reader. Therefore, an RFID tag reader may be able to read multiple RFID tags simultaneously.

### BRIEF DESCRIPTION OF THE DRAWINGS

FIGS. 1A-1B illustrate an example of a system for facilitating efficient reading of RFID tags in accordance with the present disclosure.

FIG. 2 illustrates an example of a method for facilitating efficient reading of RFID tags, in which a sequence of information bits may be encoded and distributed among a plurality of RFID tags.

FIG. 3 illustrates an example of a method for reading RFID tags that are produced in accordance with the method of FIG. 2.

FIG. 4 illustrates another example of a method for facilitating efficient reading of RFID tags, in which encoded information may be punctured using different puncturing patterns.

FIG. 5 illustrates an example of a method for reading RFID tags that are produced in accordance with the method of FIG. 4.

FIGS. 6A-6B illustrate another example of a system for facilitating efficient reading of RFID tags in accordance with the present disclosure, the system utilizing superposition coding to distribute encoded information among a plurality of RFID tags.

FIG. 6C illustrates a representation of a range of possible values for encoded information.

FIG. 7 illustrates an example of a method for facilitating efficient reading of RFID tags using the system of FIGS. 6A-6C.

FIG. 8 illustrates an example of a method for efficiently reading RFID tags that are produced in accordance with the method of FIG. 7.

FIG. 9 illustrates certain components that may be included in a computer system.

### DETAILED DESCRIPTION

From time to time, an RFID tag may not be read correctly. There are many reasons why this may happen. For example, transmission errors may occur, the RFID tag may be damaged, or the RFID tag reader may not be geometrically aligned with the RFID tag. When an RFID tag is not read correctly, it may be necessary to re-read the RFID tag. For many RFID applications, however, it is important to be able to read RFID tags very quickly, almost in real time. Having to re-read RFID tags causes delays, which can be costly.

The present disclosure is generally related to facilitating efficient reading of RFID tags. In accordance with the present disclosure, multiple RFID tags may be used to store information that would, with conventional approaches, be stored in a single RFID tag. The information may be encoded and distributed among the RFID tags such that the information is recoverable even if fewer than all of the RFID tags are read correctly.

Broadly speaking, there are at least two different scenarios in which fewer than all of the RFID tags are read correctly. In a first scenario, at least one of the RFID tags may be completely missed such that it is not read at all (i.e., no data is received from the RFID tag). To address this scenario, the information may be encoded and distributed among the RFID tags such that the information is recoverable from a subset of the RFID tags. In an example involving two RFID tags, the information may be encoded and punctured based on a first puncturing pattern, thereby producing first punctured encoded information. The information may also be encoded and punctured based on a second puncturing pattern (that is different from the first puncturing pattern), thereby producing second punctured encoded information. The first punctured encoded information may be included in a first RFID tag, and the second punctured encoded information may be included in a second RFID tag. If the first RFID tag is read (either with or without errors) but the second RFID tag is completely missed, the information may be recovered from the first RFID tag only (or vice versa).

In a second scenario, all of the RFID tags may be read (i.e., at least some data may be received from each of the RFID tags), but at least one of the RFID tags is read with one or more errors. The puncturing approach described above may be used to address this scenario. Alternatively, the information may be encoded and distributed among the RFID tags such that different portions of the information are recoverable from different RFID tags. For example, superposition encoding may be used to distribute encoded information among the RFID tags. An RFID tag reader may read all of the RFID tags (i.e., data may be received from all of the RFID tags), but the data that is received from some or all of the RFID tags may include errors. Notwithstanding the errors, however, the original information may still be recovered because of the manner in which the encoded information is distributed among the RFID tags using superposition coding.

Distributing encoded information among multiple RFID tags, instead of just a single RFID tag, can increase the speed and robustness of reading RFID tags. If the information were included in just one RFID tag (as it is with conventional approaches) and that RFID tag is not read correctly, then it would be necessary to re-read the RFID tag. If, however, the information is encoded and distributed across two (or more) RFID tags in accordance with the techniques disclosed herein, then the information may be recovered even if one (or more) of the RFID tags is not read correctly.

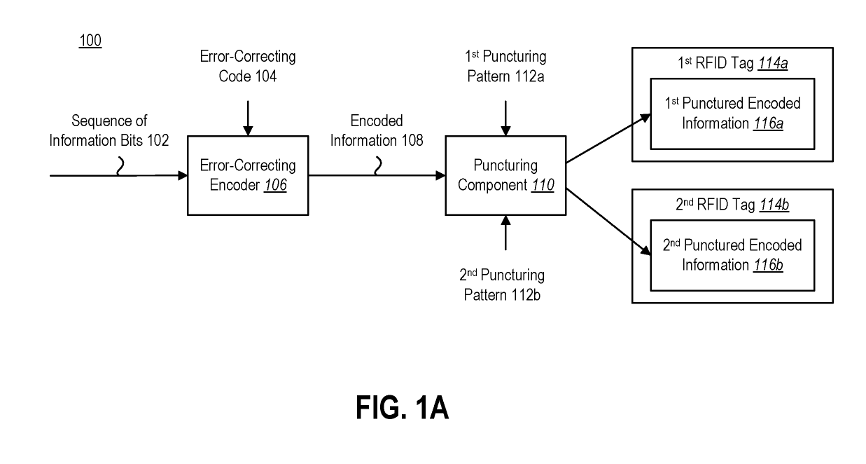

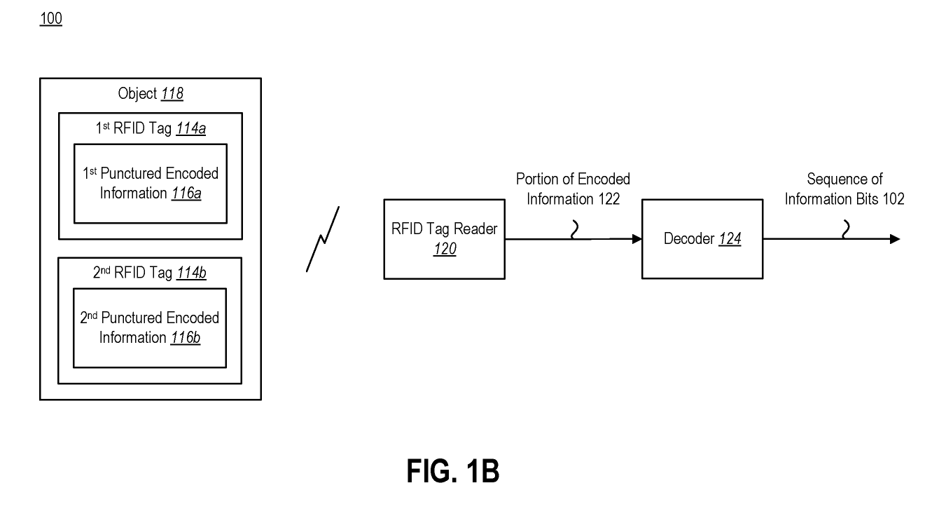

FIGS. 1A-1B illustrate an example of a system 100 for facilitating efficient reading of RFID tags 114a-b in accordance with the present disclosure. Reference is initially made to the portion of the system 100 that is shown in FIG. 1A.

A sequence of information bits 102 is shown. The sequence of information bits 102 may represent data that is related to a particular object 118 (shown in FIG. 1B), such as an identifier for the object 118, a lot or batch number corresponding to the object 118, the production date of the object 118, or other object-related information. With conventional approaches, the sequence of information bits 102 may be stored in a single RFID tag. In accordance with the present disclosure, however, multiple RFID tags 114a-b may be used to store the sequence of information bits 102. For the sake of simplicity, the system 100 is shown with just two RFID tags 114a-b, a first RFID tag 114a and a second RFID tag 114b. However, the techniques disclosed herein may be utilized in connection with more than two RFID tags 114a-b.

The sequence of information bits 102 may be encoded in a redundant way using an error-correcting code 104, thereby generating encoded information 108. The system 100 is shown with an error-correcting encoder 106 for providing this functionality. The error-correcting encoder 106 may be, for example, a forward error correction (FEC) encoder. If there are errors in the RF transmission between the RFID tags 114a-b and an RFID tag reader 120 (shown in FIG. 1B), it may be possible to correct those errors because of the redundancy introduced by the error-correcting code 104.

To further improve robustness, the encoded information 108 may be distributed among a plurality of RFID tags 114a-b. The encoded information 108, which is an encoded representation of the sequence of information bits 102, may be distributed among the first RFID tag 114a and the second RFID tag 114b such that recovering the sequence of information bits 102 does not require both of the RFID tags 114a-b to be read correctly. In some implementations, the encoded information 108 may be distributed among the first RFID tag 114a and the second RFID tag 114b such that the sequence of information bits 102 may be recovered from a subset of the RFID tags 114a-b (e.g., if the first RFID tag 114a is read correctly but the second RFID tag 114b is completely missed, or vice versa).

In the depicted implementation, in order to distribute the encoded information 108 among the RFID tags 114a-b, the encoded information 108 may be punctured multiple times based on different puncturing patterns 112a-b. For example, the encoded information 108 may be punctured based on a first puncturing pattern 112a, thereby producing first punctured encoded information 116a. The encoded information 108 may also be punctured based on a second puncturing pattern 112b, thereby producing second punctured encoded information 116b. The system 100 is shown with a puncturing component 110 for providing this functionality.

The first puncturing pattern 112a may be different from the second puncturing pattern 112b, such that the first punctured encoded information 116a may be different from the second punctured encoded information 116b. The first puncturing pattern 112a and the second puncturing pattern 112b may be selected such that the sequence of information bits 102 can be recovered from either the first punctured encoded information 116a or the second punctured encoded information 116b. In other words, it may not be necessary to correctly read both of the RFID tags 114a-b in order to recover the sequence of information bits 102. Instead, it may be possible to recover the sequence of information bits 102 even if just one of the RFID tags 114a-b is read correctly.

Reference is now made to the portion of the system 100 that is shown in FIG. 1B. The RFID tags 114a-b may be attached to an object 118. At some point, an RFID tag reader 120 may be used to attempt to read the RFID tags 114a-b. This may occur under circumstances where it may be important to be able to read the RFID tags 114a-b quickly. For example, although just a single object 118 is shown in FIG. 1B, an RFID tag reader 120 may be used in an environment (e.g., a retail environment) where there are many different objects with RFID tags that should be read as quickly as possible.

As discussed above, encoded information 108 may be distributed among the RFID tags 114a-b. When the RFID tag reader 120 attempts to read the RFID tags 114a-b, the RFID tag reader 120 may not be able to correctly read both of the RFID tags 114a-b. As a result, the RFID tag reader 120 may only receive a portion 122 of the encoded information 108 that is distributed among the RFID tags 114a-b. For example, the RFID tag reader 120 may receive the first punctured encoded information 116a from the first RFID tag 114a with errors, but may not receive the second punctured encoded information 116b from the second RFID tag 114b (or vice versa). Alternatively, the RFID tag reader 120 may receive the first punctured encoded information 116a from the first RFID tag 114a without errors, and may receive the second punctured encoded information 116b from the second RFID tag 114b with one or more errors (or vice versa). In either case, a decoder 124 may still be able to recover the sequence of information bits 102 based on the portion 122 of the encoded information 108 that is received by the RFID tag reader 120. Thus, it may be possible to recover the sequence of information bits 102 even if one or more of the RFID tags 114a-b are not read correctly.

For example, consider a scenario in which the RFID tag reader 120 reads the first RFID tag 114a correctly, but does not read the second RFID tag 114b correctly. In this case, the RFID tag reader 120 may receive the first punctured encoded information 116a from the first RFID tag 114a, but may not receive the second punctured encoded information 116b from the second RFID tag 114b. The RFID tag reader 120 may not receive the second punctured encoded information 116b at all, or the RFID tag reader 120 may receive a noisy version of the second punctured encoded information 116b (in other words, a version of the second punctured encoded information 116b that includes one or more errors). Even if the second RFID tag 114b is not read correctly, however, a decoder 124 may still be able to recover the sequence of information bits 102 from the first punctured encoded information 116a, even without the second punctured encoded information 116b. In this way, the sequence of information bits 102 may be recovered from a subset of the RFID tags 114a-b.

Consider a specific example in which the sequence of information bits 102 includes four bits: i₁, i₂, i₃, and i₄. If the error-correcting code 104 is a rate 1/3 convolutional code, then the encoded information 108 may include twelve bits: c₁, c₂, . . . c₁₂. Puncturing the encoded information 108 in accordance with a first puncturing pattern 112a may produce first punctured encoded information 116a that includes bits c₁, c₂, c₅, c₆, c₉, c₁₀. Puncturing the encoded information 108 in accordance with a second puncturing pattern 112b may produce second punctured encoded information 116b that includes bits c₃, c₄, c₇, c₈, c₁₁, c₁₂. The first punctured encoded information 116a may be included in a first RFID tag 114a, and the second punctured encoded information 116b may be included in a second RFID tag 114b. Thus, half the bits of the encoded information 108 may be allocated to each RFID tag 114a-b in a way that preserves the overall structure of the code.

In alternative implementations, the encoded information 108 may be distributed among more than two RFID tags 114a-b. The greater the number of RFID tags, the greater the likelihood of recovering the sequence of information bits 102. For example, suppose the sequence of information bits 102 is encoded and distributed among three RFID tags. It is reasonably likely that at least two of these RFID tags will be read successfully, which makes it reasonably likely that the sequence of information bits 102 will be recovered without having to re-read any of the RFID tags.

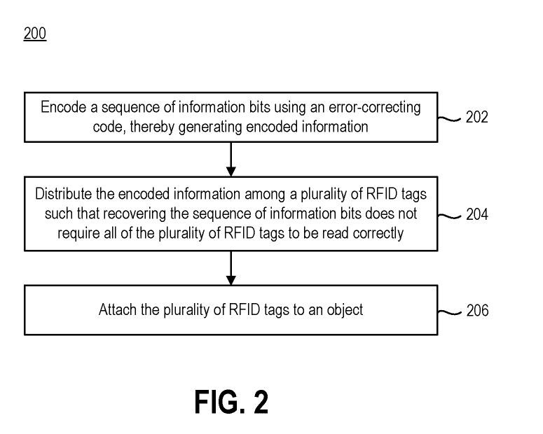

FIG. 2 illustrates an example of a method 200 for facilitating efficient reading of RFID tags 114a-b in accordance with the present disclosure. The method 200 may include encoding 202 a sequence of information bits 102 using an error-correcting code 104, thereby generating encoded information 108.

The encoded information 108 may be distributed 204 among a plurality of RFID tags 114a-b such that recovering the sequence of information bits 102 does not require all of the plurality of RFID tags 114a-b to be read correctly. In some implementations, the encoded information 108 may be distributed among the RFID tags 114a-b such that the sequence of information bits 102 may be recovered from a subset of the RFID tags 114a-b. For example, the sequence of information bits 102 may be recovered if the first RFID tag 114a is read correctly but the second RFID tag 114b is not read at all. Alternatively, as will be discussed in greater detail below, the encoded information 108 may be distributed among the RFID tags 114a-b such that different portions of the sequence of information bits 102 may be recovered from different RFID tags 114a-b. In this case, the sequence of information bits 102 may be recovered if the first RFID tag 114a and the second RFID tag 114b are both read, but with one or more errors.

Once the encoded information 108 has been distributed 204 among the RFID tags 114a-b, the RFID tags 114a-b may then be attached 206 to an object 118. At a subsequent point in time, an RFID tag reader 120 may be used to attempt to read the RFID tags 114a-b. Even if the RFID tag reader 120 does not correctly read both of the RFID tags 114a-b, it may still be possible to recover the sequence of information bits 102.

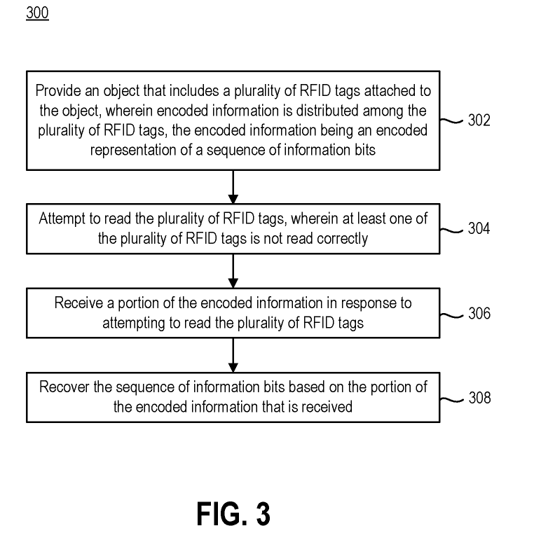

FIG. 3 illustrates an example of a method 300 for efficiently reading RFID tags 114a-b in accordance with the present disclosure. The method 300 may include providing 302 an object 118 that includes a plurality of RFID tags 114a-b attached to the object 118. Encoded information 108 may be distributed among the plurality of RFID tags 114a-b. The encoded information 108 may be an encoded representation of a sequence of information bits 102.

An RFID tag reader 120 may be used to attempt to read 304 the plurality of RFID tags 114a-b. Under some circumstances, at least one of the plurality of RFID tags 114a-b may not be read correctly. For example, the RFID tag reader 120 may read a first RFID tag 114a correctly but may not read a second RFID tag 114b at all (or vice versa). Alternatively, the RFID tag reader 120 may read both of the RFID tags 114a-b, but the information that is read from either or both of the RFID tags 114a-b may include errors.

If the RFID tag reader 120 attempts to read 304 the plurality of RFID tags 114a-b but is not able to correctly read the plurality of RFID tags 114a-b, the RFID tag reader 120 may only receive 306 a portion 122 of the encoded information 108 that is distributed among the RFID tags 114a-b. However, a decoder 124 may still be able to recover 308 the sequence of information bits 102 based on the portion 122 of the encoded information 108 that is received by the RFID tag reader 120. Thus, it may be possible to recover the sequence of information bits 102 even if one or more of the RFID tags 114a-b are not read correctly.

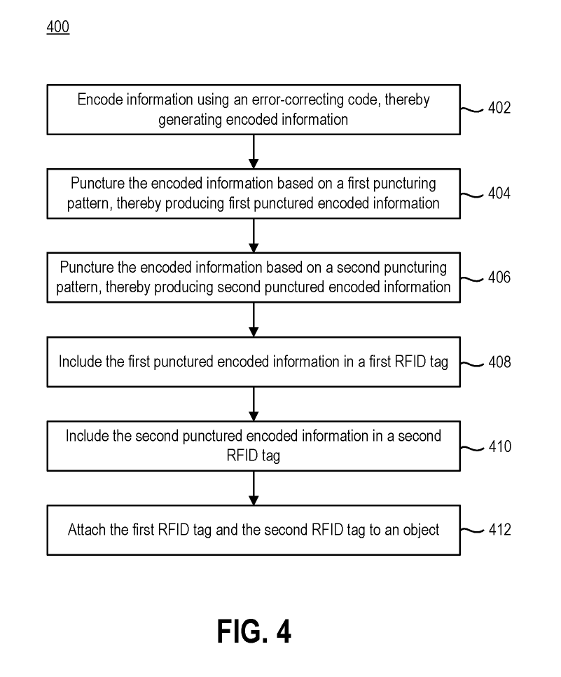

FIG. 4 illustrates another example of a method 400 for facilitating efficient reading of RFID tags 114a-b in accordance with the present disclosure. The method 400 may include encoding 402 a sequence of information bits 102 using an error-correcting code 104, thereby generating encoded information 108.

The encoded information 108 may be punctured 404 based on a first puncturing pattern 112a, thereby producing first punctured encoded information 116a. The encoded information 108 may also be punctured 406 based on a second puncturing pattern 112b, thereby producing second punctured encoded information 116b. The first puncturing pattern 112a may be different from the second puncturing pattern 112b, such that the first punctured encoded information 116a may be different from the second punctured encoded information 116b.

The first punctured encoded information 116a may be included 408 in a first RFID tag 114a, and the second punctured encoded information 116b may be included 410 in a second RFID tag 114b. The RFID tags 114a-b may then be attached 412 to an object 118. The first puncturing pattern 112a and the second puncturing pattern 112b may be selected such that the sequence of information bits 102 can be recovered from either the first punctured encoded information 116a or the second punctured encoded information 116b. Therefore, it may not be necessary to correctly read both of the RFID tags 114a-b in order to recover the sequence of information bits 102.

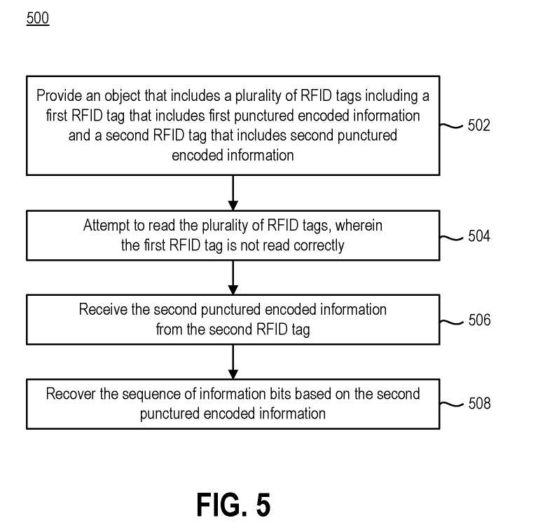

FIG. 5 illustrates another example of a method 500 for efficiently reading RFID tags 114a-b in accordance with the present disclosure. The method 500 may include providing 502 an object 118 that includes a plurality of RFID tags 114a-b attached to the object 118. The plurality of RFID tags 114a-b may include a first RFID tag 114a that includes first punctured encoded information 116a and a second RFID tag 114b that includes second punctured encoded information 116b.

An RFID tag reader 120 may be used to attempt to read 504 the plurality of RFID tags 114a-b. One of the plurality of RFID tags 114a-b may not be read correctly. For example, suppose the second RFID tag 114b is read correctly, but the first RFID tag 114a is not read correctly (either completely missed or read with error(s)). In this case, the RFID tag reader 120 may not receive the first punctured encoded information 116a from the first RFID tag 114a, or the first punctured encoded information 116a may be received but with error(s). However, the RFID tag reader 120 may receive 506 the second punctured encoded information 116b from the second RFID tag 114b.

A decoder 124 may be able to recover 508 the sequence of information bits 102 based on the second punctured encoded information 116b, even without the first punctured encoded information 116a. Thus, the sequence of information bits 102 may be recovered from a subset of the RFID tags 114a-b.

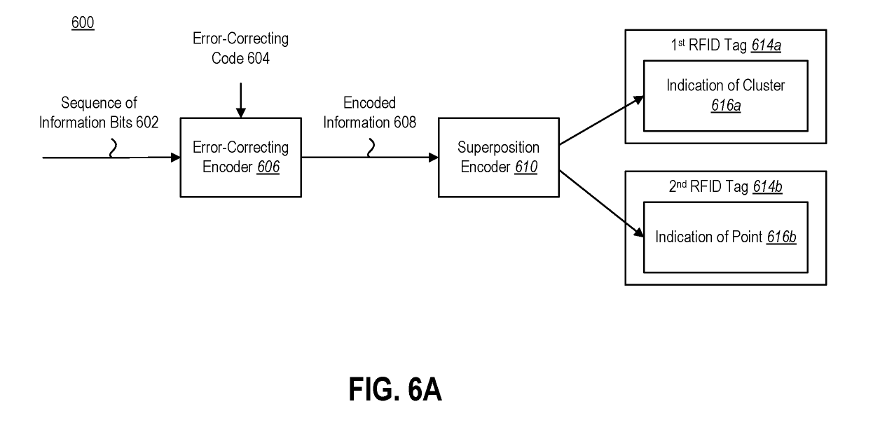

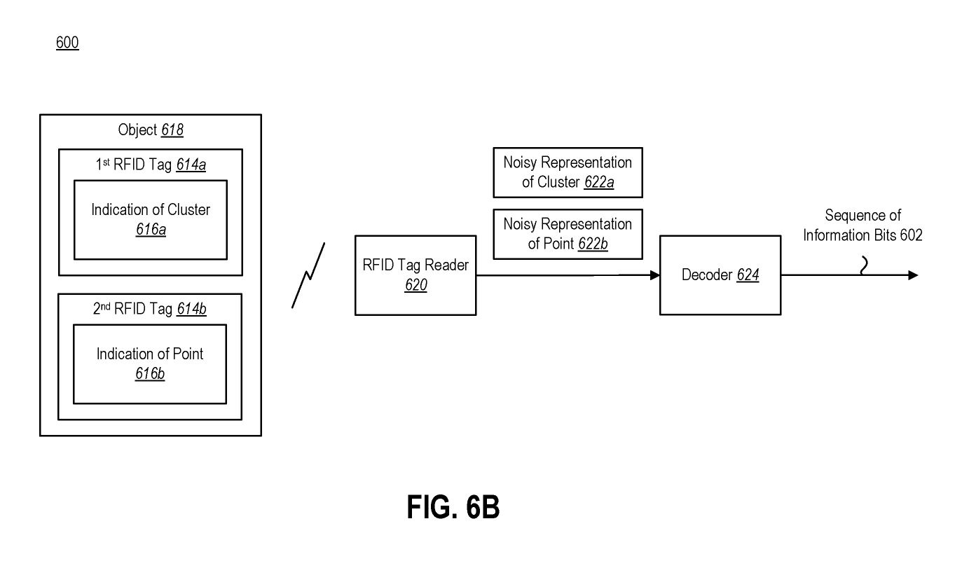

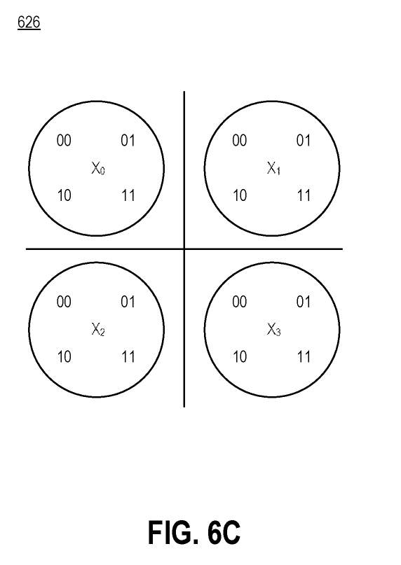

FIGS. 6A-B illustrate another example of a system 600 for facilitating efficient reading of RFID tags 614a-b in accordance with the present disclosure. In this example, encoded information 608 may be distributed among a plurality of RFID tags 614a-b such that different portions of the sequence of information bits 602 may be recovered from different RFID tags 614a-b.

Reference is initially made to the portion of the system 600 that is shown in FIG. 6A. An error-correcting encoder 606 may encode a sequence of information bits 602 using an error-correcting code 604, thereby generating encoded information 608.

In this example, superposition coding may be used to distribute the encoded information 608 among a plurality of RFID tags 614a-b, including a first RFID tag 614a and a second RFID tag 614b. Reference is briefly made to FIG. 6C, which illustrates a representation 626 of a range of possible values for the encoded information 608. As shown, the range of possible values for the encoded information 608 may be represented as a plurality of clusters x₀, x₁, x₂, x₃, and each of the clusters x₀, x₁, x₂, x₃ may include a plurality of points 00, 01, 10, 11. Referring to both FIG. 6A and FIG. 6C, the encoded information 608 may be distributed among the RFID tags 614a-b such that the first RFID tag 614a includes an indication 616a of a cluster from among the clusters x₀, x₁, x₂, x₃, and the second RFID tag 614b includes an indication 616b of a point from among the points 00, 01, 10, 11 in the indicated cluster. For example, the first RFID tag 614a may include an indication 616a of the cluster x₀, and the second RFID tag 614b may include an indication 616b of the point 00 in the cluster x₀.

Reference is now made to the portion of the system 600 that is shown in FIG. 6B. The RFID tags 614a-b may be attached to an object 618. When an RFID tag reader 620 attempts to read the RFID tags 614a-b, the RFID tag reader 620 may not be able to correctly read the RFID tags 614a-b. The RFID tag reader 620 may receive information from both of the RFID tags 614a-b, but the information that is received from either or both of the RFID tags 614a-b may include errors. In other words, the RFID tag reader 620 may receive a noisy representation 622a of the data in the first RFID tag 614a (i.e., the indication 616a of a cluster) and/or a noisy representation 622b of the data in the second RFID tag 614b (i.e., the indication 616b of a point).

Notwithstanding the errors in the information that is received from the RFID tags 614a-b, the sequence of information bits 602 may still be recovered from the noisy representations 622a-b of the data in the RFID tags 614a-b. The noisy representations 622a-b of the data in the RFID tags 614a-b may be sufficiently close to the actual data in the RFID tags 614a-b (i.e., the indication 616a of a cluster in the first RFID tag 614a and the indication 616b of a point in the cluster in the second RFID tag 614b) to enable a decoder 624 to recover the sequence of information bits 602.

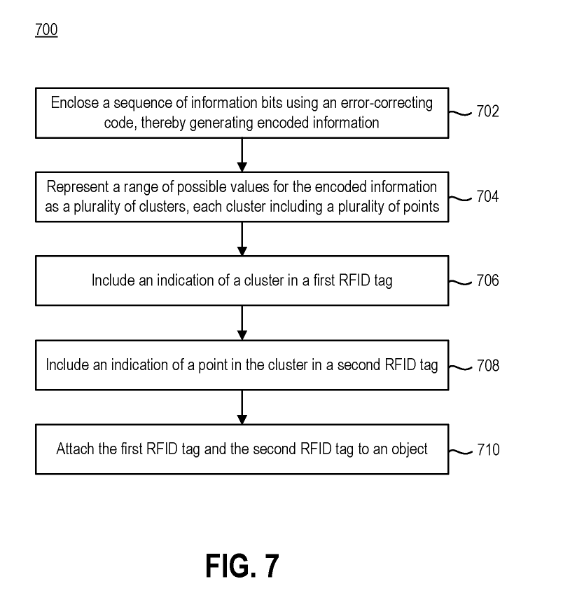

FIG. 7 illustrates another example of a method 700 for facilitating efficient reading of RFID tags 614a-b in accordance with the present disclosure. The method 700 may include encoding 702 a sequence of information bits 602 using an error-correcting code 604, thereby generating encoded information 608.

A range of possible values for the encoded information 608 may be represented 704 as a plurality of clusters, such as the clusters x₀, x₁, x₂, x₃ shown in FIG. 6C. Each of the clusters x₀, x₁, x₂, x₃ may include a plurality of points 00, 01, 10, 11.

An indication 616a of a cluster from among the clusters x₀, x₁, x₂, x₃ may be included 706 in a first RFID tag 614a. An indication 616b of a point from among the points 00, 01, 10, 11 in the indicated cluster may be included 708 in a second RFID tag 614b. The RFID tags 614a-b may then be attached 710 to an object 618. It may not be necessary to correctly read both of the RFID tags 614a-b in order to recover the sequence of information bits 602. Even if an RFID tag reader 620 receives a noisy representation 622a of the data in the first RFID tag 614a (i.e., the indication 616a of a cluster) and/or a noisy representation 622b of the data in the second RFID tag 614b (i.e., the indication 616b of a point), this may be sufficient to be able to recover the sequence of information bits 602.

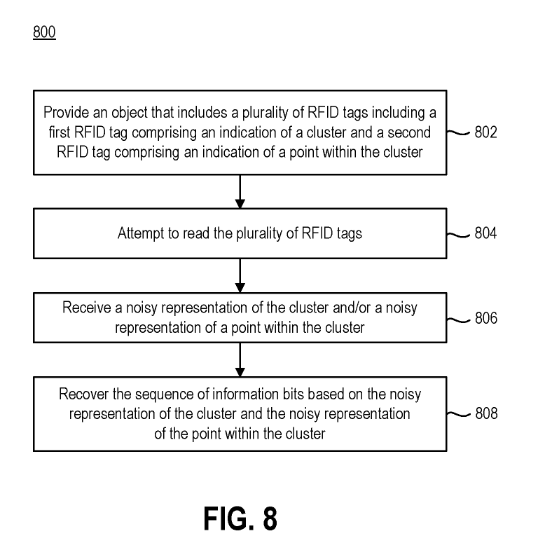

FIG. 8 illustrates another example of a method 800 for efficiently reading RFID tags 614a-b in accordance with the present disclosure. The method 800 may include providing 802 an object 618 that includes a plurality of RFID tags 614a-b attached to the object 618. The plurality of RFID tags 614a-b may include a first RFID tag 614a that includes an indication 616a of a cluster from among a plurality of clusters (such as the clusters x₀, x₁, x₂, x₃ shown in FIG. 6C). The plurality of RFID tags 614a-b may also include a second RFID tag 614b that includes an indication 616b of a point from among a plurality of points (such as the points 00, 01, 10, 11 shown in FIG. 6C) that are associated with the cluster.

An RFID tag reader 620 may be used to attempt to read 804 the plurality of RFID tags 614a-b. However, the RFID tag reader 620 may not be able to correctly read the RFID tags 614a-b. For example, the RFID tag reader 620 may receive 806 a noisy representation 622a of the data in the first RFID tag 614a (i.e., the indication 616a of a cluster) and/or a noisy representation 622b of the data in the second RFID tag 614b (i.e., the indication 616b of a point).

Even though the RFID tag reader 620 may not be able to correctly read the RFID tags 614a-b, it may still be possible to recover 808 the sequence of information bits 602 based on the noisy representations 622a-b of the data in the RFID tags 614a-b. Thus, the sequence of information bits 602 may be recovered even if one or both of the RFID tags 614a-b are not read correctly.

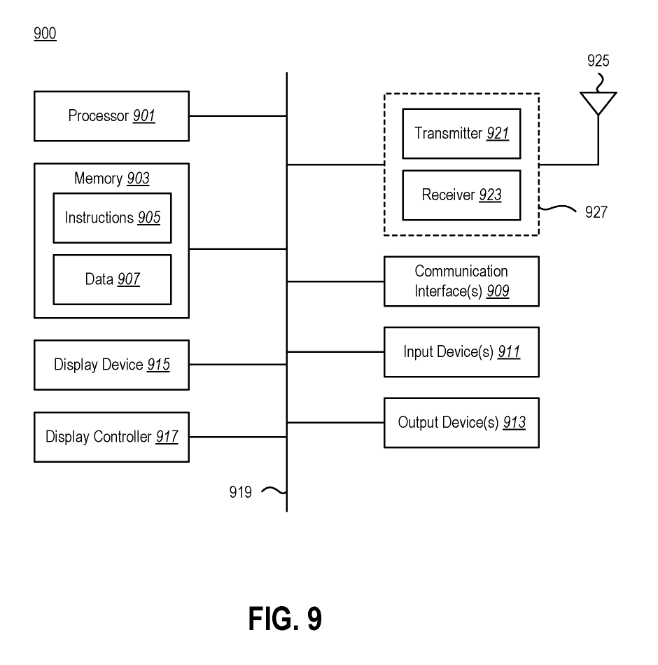

FIG. 9 illustrates certain components that may be included in a computer system 900. One or more computer systems 900 may be used to implement aspects of the present disclosure. The computer system 900 includes a processor 901. The processor 901 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 901 may be referred to as a central processing unit (CPU). Although just a single processor 901 is shown in the computer system 900 of FIG. 9, in an alternative configuration, a combination of processors (e.g., an ARM and DSP) could be used.

The computer system 900 also includes memory 903. The memory 903 may be any electronic component capable of storing electronic information. For example, the memory 903 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 905 and data 907 may be stored in the memory 903. The instructions 905 may be executable by the processor 901 to implement some or all of the functionality that has been described herein.

The instructions 905 may be executable by the processor 901 to perform some or all of the operations described above in connection with the methods 200, 300, 400, 500, 700, 800 shown in FIGS. 2-5 and 7-8. Any of the various examples of modules and components described herein (such as the error-correcting encoder 106, 606, puncturing component 110, decoder 124, 624, and superposition encoder 610) may be implemented, partially or wholly, as instructions 905 stored in memory 903 and executed by the processor 901.

Executing the instructions 905 may involve the use of the data 907 that is stored in the memory 903. Any of the various examples of data described herein may be among the data 907 that is stored in memory 903 and used during execution of the instructions 905 by the processor 901. Some examples of data 907 that may be stored in the memory 903 and used in connection with executing the instructions 905 include a sequence of information bits 102, 602, an error-correcting code 104, 604, encoded information 108, 608, puncturing patterns 112a-b, punctured encoded information 116a-b, a portion 122 of encoded information 108 obtained by an RFID tag reader 120, a representation 626 of a range of possible values for encoded information 608, an indication 616a of a cluster, an indication 616b of a point, and noisy representations 622a-b obtained by an RFID tag reader 620.

The computer system 900 may also include one or more wireless communication interfaces, which may include a transmitter 921 and a receiver 923. The transmitter 921 and receiver 923 may be collectively referred to as a transceiver 927. The transceiver 927 may facilitate wireless transmission and reception of signals to and from other devices via an antenna 925. The transceiver 927 may facilitate wireless communication between devices, or between objects and devices, as described herein. For example, the transceiver 927 may facilitate wireless communication between an RFID tag 114a-b, 614a-b and an RFID tag reader 120, 620. As another example, the transceiver 927 may facilitate wireless communication between an RFID tag reader 120, 620 and a computer system 900 that implements a decoder 124, 624. Some examples of wireless communication interfaces include a wireless adapter that operates in accordance with an Institute of Electrical and Electronics Engineers (IEEE) 802.11 wireless communication protocol, a cellular network interface, a Bluetooth® wireless communication interface, and an infrared (IR) communication interface. In some implementations, the computer system 900 may include (not shown) multiple transmitters, multiple antennas, multiple receivers and/or multiple transceivers.

A computer system 900 may also include one or more other communication interfaces 909, at least some of which may be based on wired communication technology. Some examples of other communication interfaces 909 that may be utilized in a computer system 900 include a Universal Serial Bus (USB) and an Ethernet adapter. The communication interface(s) 909 may facilitate at least some of the communication between devices as described herein.

The computer system 900 may also include one or more input devices 911 and one or more output devices 913, which may be used to provide user input. Some examples of input devices 911 include a keyboard, mouse, microphone, remote control device, button, joystick, trackball, touchpad, and lightpen. Some examples of output devices 913 include a speaker and a printer. One specific type of output device that is typically included in a computer system 900 is a display device 915. Some examples of information that may be displayed to a user of the computer system 900 via the display device 915 include information that is obtained by reading RFID tags 114a-b, 614a-b and the output provided by a decoder 124, 624 (e.g., a sequence of information bits 102, 602). The display device 915 may utilize any suitable image projection technology, such as liquid crystal display (LCD), light-emitting diode (LED), gas plasma, electroluminescence, or the like. The display device 915 may be a touchscreen display. A display controller 917 may also be provided, for converting data 907 stored in the memory 903 into text, graphics, and/or moving images (as appropriate) shown on the display device 915.

The various components of the computer system 900 may be coupled together by one or more buses, which may include a power bus, a control signal bus, a status signal bus, a data bus, etc. For the sake of clarity, the various buses are illustrated in FIG. 9 as a bus system 919.

An RFID tag reader 120, 620 may include one or more of the components shown in FIG. 9. For example, an RFID tag reader 120, 620 may include a wireless communication interface including a transceiver 927 and an antenna 925. An RFID tag reader 120, 620 may also include a processor 901 and memory 903. An RFID tag 114a-b, 614a-b may also include a wireless communication interface, a processor 901, and memory 903.

A method for facilitating efficient reading of RFID tags is disclosed. The method may include encoding a sequence of information bits using an error-correcting code to generate encoded information. The sequence of information bits may be associated with an object. The encoded information may be distributed among a plurality of RFID tags such that recovering the sequence of information bits does not require all of the plurality of RFID tags to be read correctly.

In some implementations, the encoded information may be distributed among the plurality of RFID tags such that the sequence of information bits is recoverable from a subset of the plurality of RFID tags. The encoded information may be punctured based on a first puncturing pattern, thereby producing first punctured encoded information. The encoded information may also be punctured based on a second puncturing pattern, thereby producing second punctured encoded information. The first puncturing pattern may be different from the second puncturing pattern such that the first punctured encoded information may be different from the second punctured encoded information. The sequence of information bits may be recoverable from either the first punctured encoded information or the second punctured encoded information.

In some implementations, the encoded information may be distributed among the plurality of RFID tags such that different portions of the sequence of information bits are recoverable from different RFID tags. Superposition coding may be used to distribute the encoded information among the plurality of RFID tags. A range of possible values for the encoded information may be represented as a plurality of clusters. Each cluster may include a plurality of points. An indication of a cluster from among the plurality of clusters may be included in a first RFID tag. An indication of a point from among the plurality of points in the cluster may be included in a second RFID tag.

A method for efficiently reading RFID tags is also disclosed. The method may include attempting to read a plurality of RFID tags that are attached to an object. Encoded information may be distributed among the plurality of RFID tags. The encoded information may be an encoded representation of a sequence of information bits. At least one of the plurality of RFID tags may not be read correctly. The method may also include receiving a portion of the encoded information and recovering the sequence of information bits from the portion of the encoded information.

In some implementations, the sequence of information bits may be recovered from a subset of the plurality of RFID tags. The plurality of RFID tags may include a first RFID tag that includes first punctured encoded information and a second RFID tag that includes second punctured encoded information. The second punctured encoded information may be different from the first punctured encoded information. The sequence of information bits may be recovered from the first punctured encoded information or the second punctured encoded information.

In some implementations, different portions of the sequence of information bits may be recovered from different RFID tags. A range of possible values for the encoded information may be represented as a plurality of clusters. Each cluster may include a plurality of points. The encoded information may be distributed among the plurality of RFID tags such that a first RFID tag indicates a cluster from among the plurality of clusters and a second RFID tag indicates a point from among the plurality of points in the cluster.

A system that facilitates efficient reading of RFID tags is disclosed. The system includes an object and a plurality of RFID tags attached to the object. Encoded information may be distributed among the plurality of RFID tags. The encoded information may be an encoded representation of a sequence of information bits. The sequence of information bits may be recoverable even if fewer than all of the plurality of RFID tags are read correctly.

In some implementations, the encoded information may be distributed among the plurality of RFID tags such that the sequence of information bits is recoverable from a subset of the plurality of RFID tags. The plurality of RFID tags may include a first RFID tag that includes first punctured encoded information and a second RFID tag that includes second punctured encoded information. The second punctured encoded information may be different from the first punctured encoded information. The sequence of information bits may be recoverable from the first punctured encoded information or the second punctured encoded information.

In some implementations, the encoded information may be distributed among the plurality of RFID tags such that different portions of the sequence of information bits are recoverable from different RFID tags. A range of possible values for the encoded information may be represented as a plurality of clusters. Each cluster may include a plurality of points. The encoded information may be distributed among the plurality of RFID tags such that a first RFID tag indicates a cluster from among the plurality of clusters and a second RFID tag indicates a point from among the plurality of points in the cluster.

In some implementations, the system may additionally include an RFID tag reader that is configured to attempt to read the plurality of RFID tags. The system may also include a decoder that is configured to recover the sequence of information bits based on a portion of the encoded information received by the RFID tag reader.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1-6. (canceled)

7. A method for facilitating efficient reading of radio frequency identification (RFID) tags, comprising:
encoding a sequence of information bits using an error-correcting code to generate encoded information, the sequence of information bits being associated with an object; and
distributing the encoded information among a plurality of RFID tags such that the sequence of information bits is recoverable when at least some data is received from each of the plurality of RFID tags but the received data comprises a noisy representation of the data in at least one of the plurality of RFID tags.

8. The method of claim 7, wherein the encoded information is generated using a convolution code.

9. The method of claim 8, wherein distributing the encoded information among the plurality of RFID tags comprises:
puncturing the encoded information based on a first puncturing pattern, thereby producing first punctured encoded information; and
puncturing the encoded information based on a second puncturing pattern, thereby producing second punctured encoded information.

10. The method of claim 9, wherein:
the first puncturing pattern is different from the second puncturing pattern such that the first punctured encoded information is different from the second punctured encoded information; and
the sequence of information bits is recoverable from either the first punctured encoded information or the second punctured encoded information.

11. The method of claim 7, wherein the encoded information is distributed among the plurality of RFID tags such that different portions of the sequence of information bits are recoverable from different RFID tags.

12. The method of claim 11, further comprising using superposition coding to distribute the encoded information among the plurality of RFID tags.

13. The method of claim 12, further comprising:
representing a range of possible values for the encoded information as a plurality of clusters, each cluster comprising a plurality of points;
including an indication of a cluster from among the plurality of clusters in a first RFID tag; and
including an indication of a point from among the plurality of points in the cluster in a second RFID tag.

14. A system that facilitates efficient reading of radio frequency identification (RFID) tags, comprising:
an object; and
a plurality of RFID tags attached to the object, wherein encoded information is distributed among the plurality of RFID tags, the encoded information being an encoded representation of a sequence of information bits, and wherein the sequence of information bits being recoverable even if fewer than all of the plurality of RFID tags are read correctly.

15. The system of claim 14, wherein the encoded information is generated using a convolution code.

16. The system of claim 14, wherein the plurality of RFID tags comprise:
a first RFID tag that comprises first punctured encoded information generated from puncturing the encoded information based on a first puncturing pattern; and
a second RFID tag that comprises second punctured encoded information generated from puncturing the encoded information based on a second puncturing pattern, the second punctured encoded information being different from the first punctured encoded information.

17. The system of claim 16, wherein the sequence of information bits is recoverable from the first punctured encoded information or the second punctured encoded information.

18. The system of claim 14, wherein the encoded information is distributed among the plurality of RFID tags such that different portions of the sequence of information bits are recoverable from different RFID tags.

19. The system of claim 18, wherein:
a range of possible values for the encoded information is represented as a plurality of clusters, each cluster comprising a plurality of points; and
the encoded information is distributed among the plurality of RFID tags such that a first RFID tag indicates a cluster from among the plurality of clusters and a second RFID tag indicates a point from among the plurality of points in the cluster.

20. The system of claim 14, further comprising:
an RFID tag reader that is configured to attempt to read the plurality of RFID tags; and
a decoder that is configured to recover the sequence of information bits based on a portion of the encoded information received by the RFID tag reader.
